(19) United States
(12) Patent Application Publication
(10) Pub. No.: US 2017/0359481 A1
(43) Pub. Date: Dec. 14, 2017

(54) PRINTING APPARATUS, PRINTING METHOD AND PROGRAM MEDIUM

(71) Applicant: Kenji YAMADA, Tokyo (JP)

(72) Inventor: Kenji YAMADA, Tokyo (JP)

(73) Assignee: Ricoh Company, Ltd., Tokyo (JP)

(21) Appl. No.: 15/607,950

(22) Filed: May 30, 2017

(30) Foreign Application Priority Data
Jun. 10, 2016 (JP) 2016-116521

(51) Int. Cl. H04N 1/32; H04N 1/203

(52) U.S. Cl. CPC H04N 1/32245; H04N 1/2034; H04N 1/32208; H04N 1/32149

(57) ABSTRACT

A printing apparatus is provided. The printing apparatus includes a processing circuitry configured to generate embedding data to be embedded in a print image to be printed out; divide the print image into two or more areas, and embed the embedding data in each of the two or more areas in such a way that placement of the embedding data is identical in each of the areas; and output the print image in which the embedding data is embedded.

### BACKGROUND OF THE INVENTION

### 1. Field of the Invention

The present invention relates to a printing apparatus, a printing method and a program medium.

### 2. Description of the Related Art

A digital watermarking technology has been known in which predetermined information is embedded in electronic data in order to prevent tampering of the electronic data, etc.

Further, an embedding technology is known in which, by applying the digital watermarking technology, the predetermined information is embedded as a fine dot pattern when printing out the electronic data as printed matter on a paper medium, etc.

According to the embedding technology, it is possible to verify whether the printed matter is genuine or not by scanning the printed-out printed matter and by extracting the embedded fine dot pattern by using a predetermined application. [Patent Document 1] Japanese Unexamined Patent Application Publication No. 2003-209676

### SUMMARY OF THE INVENTION

A printing apparatus according to an embodiment is provided. The printing apparatus has a following configuration. That is, the printing apparatus includes a processing circuitry configured to: generate embedding data to be embedded in a print image to be printed out; divide the print image into two or more areas, and embed the embedding data in each of the two or more areas in such a way that placement of the embedding data is identical in each of the areas; and output the print image in which the embedding data is embedded.

### BRIEF DESCRIPTION OF THE DRAWINGS

FIG. 1 is a first drawing illustrating an example of a system configuration of a printing system.

FIG. 2 is a drawing illustrating an example of a hardware configuration of an image forming apparatus.

FIG. 3 is a drawing illustrating an example of a hardware configuration of a server apparatus.

FIG. 4A is a drawing illustrating an example of setting information. FIG. 4B is a drawing illustrating an example of setting information.

FIG. 5 is a drawing illustrating an example of a functional structure of an embedding process unit of an image forming apparatus.

FIG. 6A is a drawing illustrating an example of arranged data. FIG. 6B is a drawing illustrating an example of arranged data.

FIG. 7 is a flowchart illustrating a flow of an embedding process.

FIG. 8 is a drawing illustrating an example of a functional structure of an analysis unit of an image forming apparatus.

FIG. 9A is an example of a method of extracting embedded embedding data. FIG. 9B is an example of an extracting method of embedded embedding data.

FIG. 10 is a flowchart illustrating a flow of an analysis process.

FIG. 11 is another example of a method of extracting embedded data.

FIG. 12 is a second drawing illustrating an example of a system configuration of a printing system.

FIG. 13 is a third drawing illustrating an example of a system configuration of a printing system.

FIG. 14 is a fourth drawing illustrating an example of a system configuration of a printing system.

### DETAILED DESCRIPTION OF THE PREFERRED EMBODIMENTS

In the case of conventional embedding technology, there is a problem in that, for example, when printing is faint in some areas of the printed matter, or when noise is included in some areas of the scanned data, embedded fine dots cannot be extracted accurately. Therefore, according to conventional embedding technology, it is difficult to achieve sufficient accuracy in verifying whether the printed matter is genuine or not.

The present invention has been made in view of the above. It is an object of the present invention to improve verification accuracy in verifying whether the printed matter is genuine or not.

According to an embodiment of the present invention, it is possible to improve verification accuracy in verifying whether the printed matter is genuine or not.

In the following, embodiments of the present invention will be described while making reference to the accompanying drawings. It should be noted that in the specification and the drawings, elements which include substantially the same functional structure are given the same reference numerals in order to avoid duplicated descriptions.

### First Embodiment

<1. System configuration of printing system>

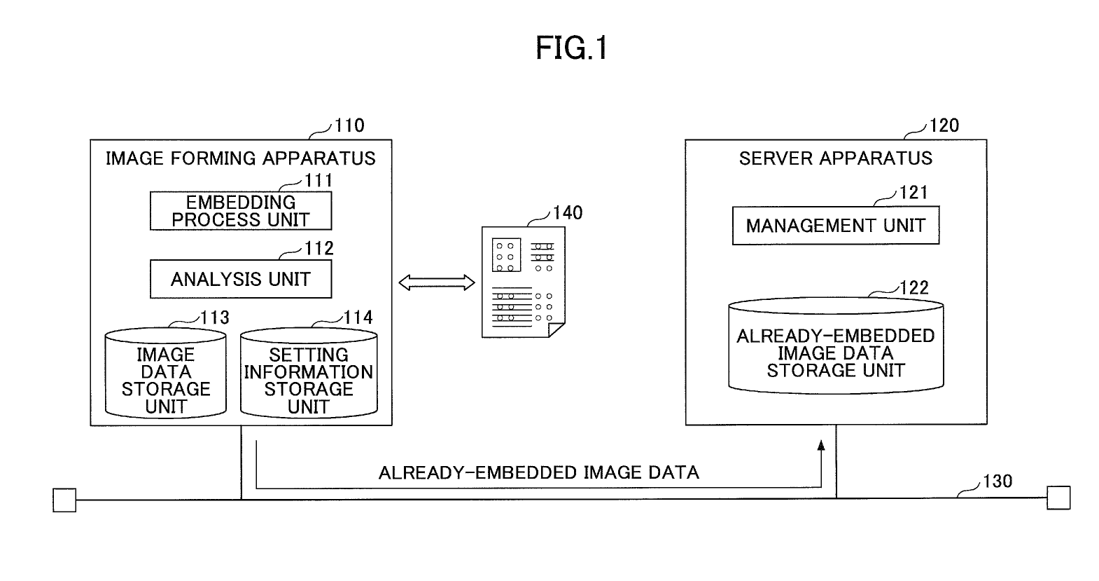

First, an overall configuration of a printing system according to a first embodiment will be described. FIG. 1 is a first drawing illustrating an example of a system configuration of a printing system 100. As illustrated in FIG. 1, the printing system 100 includes an image forming apparatus 110 and a server apparatus 120. The image for forming apparatus 110 and the server apparatus 120 are connected via a network 130 such as a LAN (Local Area Network).

The image forming apparatus 110 is an MFP (Multi-Function Peripheral) that has a printing function for printing out image data (print image) as printed matter 140 and a scanning function for scanning the printed matter 140. In the first embodiment, it is assumed that the image data to be printed out by the image forming apparatus 110 is stored in an image data storing unit 113 in advance. Further, in the first embodiment, a user of the image forming apparatus 110 chooses an image data item from image data items stored in advance in the image data storing unit 113, performs various types of settings including an image size, and inputs a print instruction.

In the image forming apparatus 110, an embedding process program and an analysis program are installed. When performing a printing out process or a scanning process, the image forming apparatus 110 functions as an embedding process unit 111 and an analysis unit 112.

In the case where a print instruction is input by a user, the embedding process unit 111 generates embedding data to be embedded in the image data by encoding information related to the image data to be printed out (print day and time, ID of a print user, file name of the image data, etc.). Further, the embedding process unit 111 embeds the generated embedding data in the image data to be printed out based on setting information stored in a setting information storing unit 114. With the above operation, it is possible for the image forming apparatus 110 to print out an embedding-data-embedded image data, in which embedding data has already been embedded, as a printed matter 140. Further, the embedding process unit 111 transmits the printed out embedding-data-embedded image data (including information related to the image data) to the server apparatus 120.

The analysis unit 112 analyzes scanned data obtained by scanning the printed matter 140 and determines whether the embedding data is embedded. The analysis unit 112 analyzes the scanned data based on setting information stored in the setting information storing unit 114.

Further, upon determining that the embedding data is embedded, the analysis unit 112 extracts the embedded embedding data from the scanned data and decodes the extracted embedding data.

Further, the analysis unit 112 displays a result of determining whether the embedding data is embedded and a result of decoding the extracted embedding data on the user interface unit of the image forming apparatus 110.

It is possible for the user to verify whether the scanned printed matter 140 is genuine or not by comparing the result of decoding displayed on the user interface unit and the embedding-data-embedded image data (including information related to the image data) transmitted to the server apparatus 120. It should be noted that “the printed matter 140 is genuine” means that the scanned printed matter 140 is the printed matter obtained by printing out the embedding-data-embedded image data which has been transmitted to the server apparatus 120.

The server apparatus 120 is an apparatus for managing the embedding-data-embedded image data printed out by the image forming apparatus 110. management program is installed in the server apparatus 120, and the server apparatus 120 functions as a management unit 121 by executing the program.

The management unit 121 receives the embedding-data-embedded image data (including information related to the image data) transmitted from the image forming apparatus 110, and stores the image data in an embedding-data-embedded image data storage unit 122. Further, in response to a request from the image forming apparatus 110, the management unit 121 transmits the embedding-data-embedded image data (including information related to the image data) to the image forming apparatus 110.

<2. Hardware configuration of apparatuses included in the printing system>

Next, hardware configurations of apparatuses (image forming apparatus 110, server apparatus 120) included in the printing system 100 will be described.

(1) Hardware configuration of the image forming apparatus 110

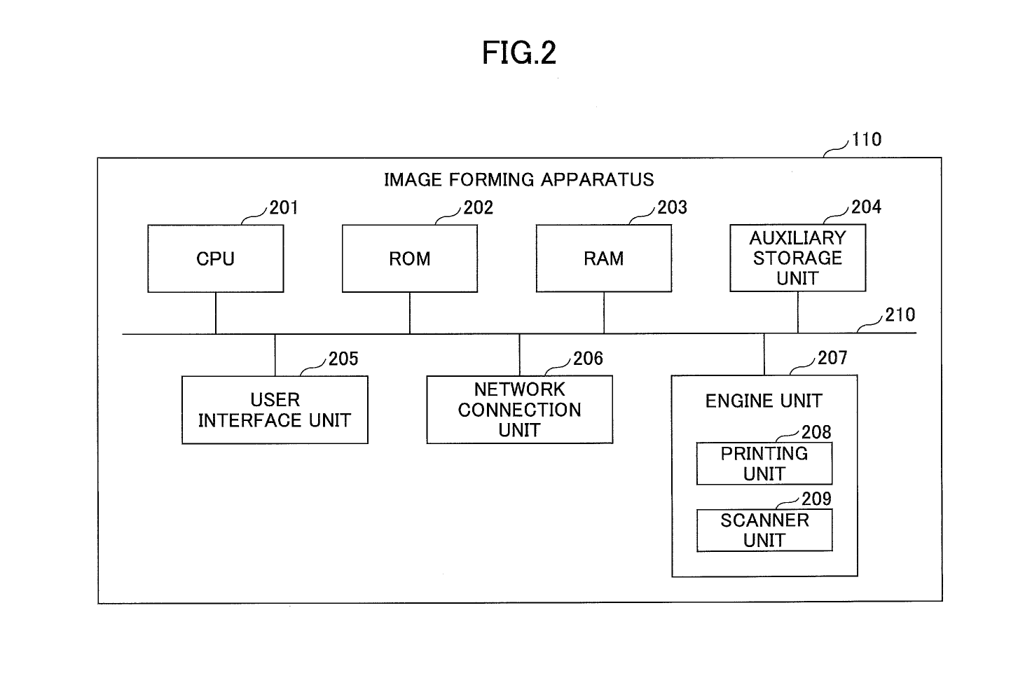

FIG. 2 is a drawing illustrating an example of a hardware configuration of an image forming apparatus 110. As illustrated in FIG. 2, the image forming apparatus 110 includes a CPU (Central Processing Unit) 201, a ROM (Read Only Memory) 220, and a RAM (Random Access Memory) 203 which form what is known as a computer. Further, the image forming apparatus 110 includes an auxiliary storage unit 204, a user interface unit 205, a network connection unit 206, and an engine unit 207. It should be noted that the above hardware units included in the image forming apparatus 110 are connected to each other via a bus 210.

The CPU 201 executes various programs (e.g., an embedding process program, an analysis program) stored in the auxiliary storage unit 204.

The ROM 202 is a non-volatile memory. The ROM 202 stores programs, data, etc., which are needed for the CPU 201 to execute the programs stored in the auxiliary storage apparatus 204. Specifically, the ROM 202 stores a BIOS (Basic Input/Output System), a boot program including an EFI (Extensible Firmware Interface), and the like.

The RAM 203 is a main memory apparatus including a DRAM (Dynamic Random Access Memory), an SRA (Static Random Access Memory), or the like. The RAM 203 functions as a work area in which the programs stored in the auxiliary storage unit 204 are expanded when the CPU 201 executes the programs.

The auxiliary storage unit 204 stores various types of programs executed by the CPU 201 and information (e.g., image data, setting information) used when the various types of programs are executed by the CPU 201.

The user interface unit 205 is an input/output device used by a user of the image forming apparatus 110 for inputting various types of instructions for the image forming apparatus 110, and used for outputting and displaying internal information (e.g., a determination result, a decoded result) of the image forming apparatus 110.

The network connection unit 206 is a device used for connecting to a network 130 and communicating with the server apparatus 120.

The engine unit 207 includes a printing unit 208 and a scanner unit 209. The printing unit 208 prints an image on a recording member based on the embedding-data-embedded image data and outputs the printed matter 140. The scanner unit 209 scans the printed matter 140 and generates scanned data.

(2) Hardware configuration of server apparatus

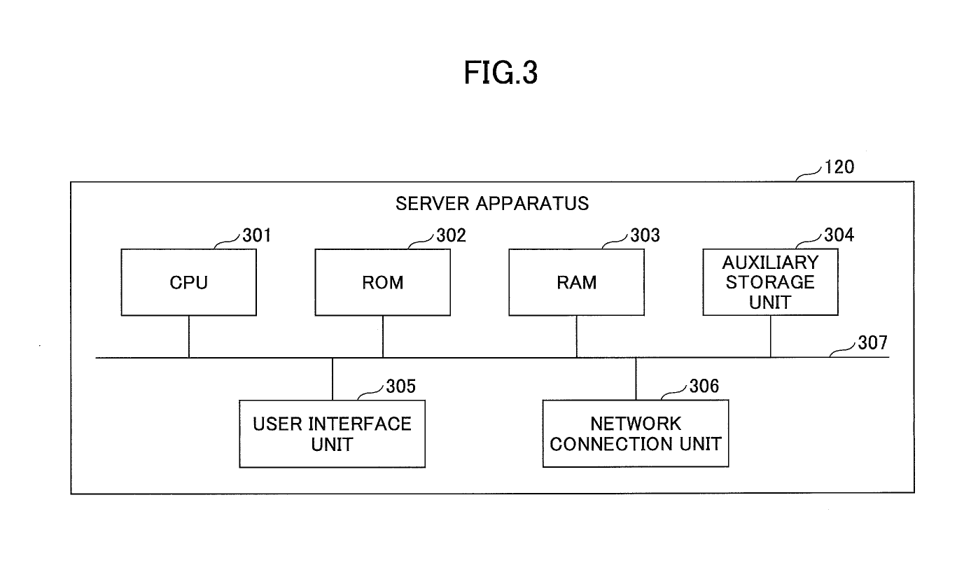

FIG. 3 is a drawing illustrating an example of a hardware configuration of a server apparatus 120. As illustrated in FIG. 3, the server apparatus 120 includes a CPU 301, a ROM 302, and a RAM 303 which form what is known as a computer. Further, the server apparatus 120 includes an auxiliary storage unit 304, a user interface unit 305, a network connection unit 306. The above hardware units included in the server apparatus 120 are connected to each other via a bus 307.

It should be noted that the above-described hardware included in the server apparatus 120 is similar to the hardware from the CPU 201 to the network connection unit 206 included in the image forming apparatus 110, and thus, descriptions thereof will be omitted.

<3. Descriptions of setting information>

Next, setting information stored in the setting information storage unit 114 of the image forming apparatus will be described. The setting information is used when the embedding process unit 111 embeds the embedding data in the image data. Further, the setting information is used when the analysis unit 112 extracts the embedded embedding data from the scanned data.

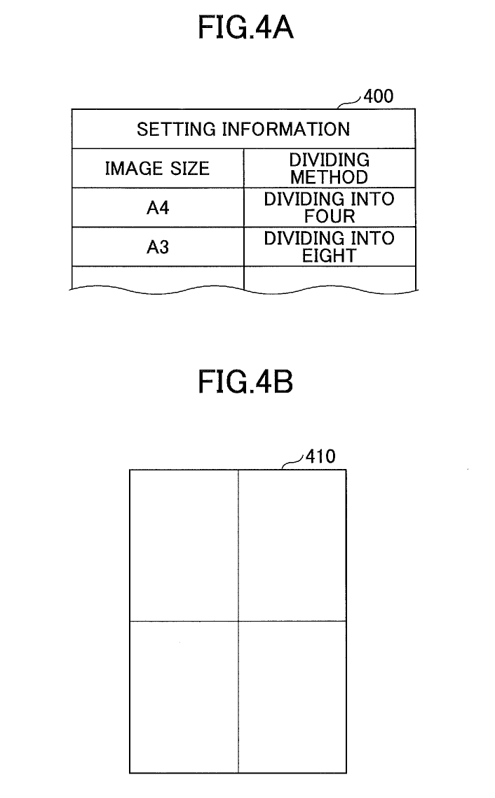

FIG. 4A is a drawing illustrating an example of setting information 400. As illustrated in FIG. 4A, the setting information 400 includes “image size” and “dividing method” as information items. In the “image size”, information related to a size of the printed matter 140 is stored. In the “dividing method”, information related to a dividing method corresponding to an image size is stored.

An example in FIG. 4A illustrates that, in the case where the image size=“A4”, the image data should be divided into four and the embedding data should be embedded. Further, an example in FIG. 4A illustrates that, in the case where the image size=“A3”, the image data should be divided by eight and the embedding data should be embedded.

FIG. 4B is a schematic drawing illustrating a dividing example in the case where the information related to the dividing method is “dividing-into-four”. As illustrated in FIG. 4B, in the case of image data whose image size=“A4” and whose placement is vertical, the embedding process unit 111 divides the image data into four areas by dividing into two in the horizontal direction and by dividing into two in the vertical direction, and embeds the embedding data in each area based on the information 410 related to the dividing method.

<4. Functional structure of embedding process unit of the image forming apparatus>

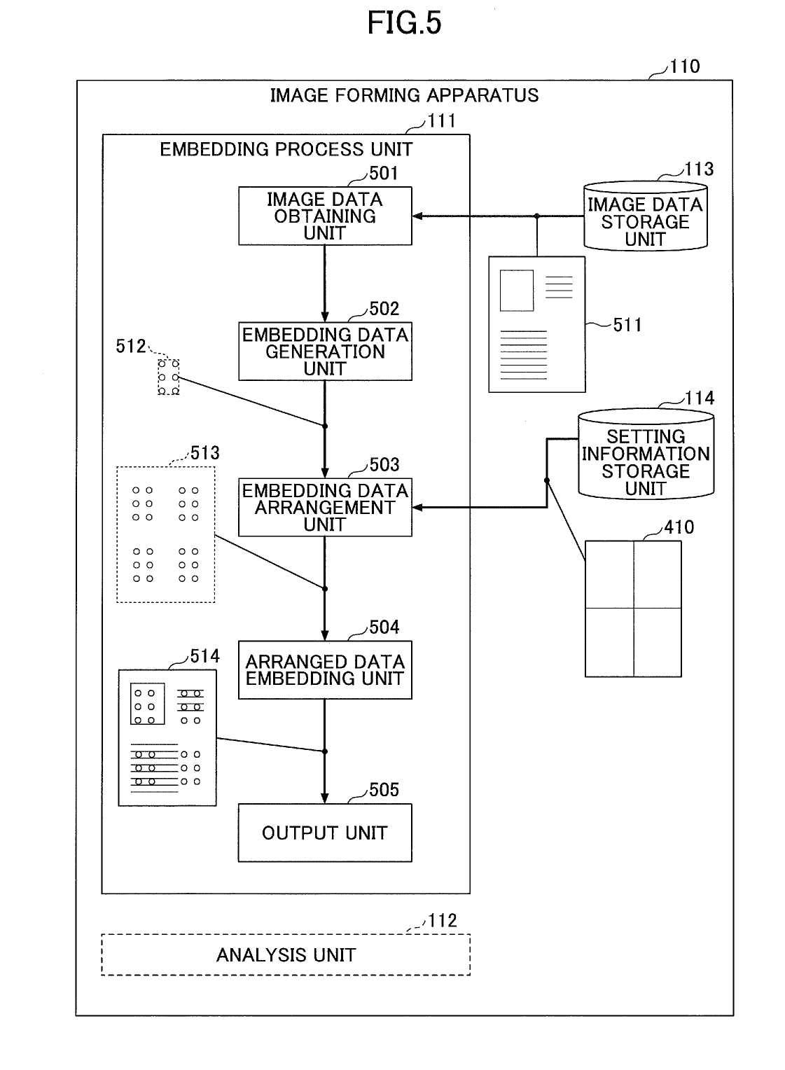

Next, a functional structure of an embedding process unit 111 of the image forming apparatus 110 will be described. FIG. 5 is a drawing illustrating an example of a functional structure of the embedding process unit 111 of the image forming apparatus 110.

As illustrated in FIG. 5, the embedding process unit 111 includes an image data obtaining unit 501, an embedding data generation unit 502, an embedding data arrangement unit 503, an arranged data embedding unit 504, and an output unit 505.

The image data obtaining unit 501 obtains user-selected image data 511 from the image data storage unit 113, and transmits the image data 511 to the embedding data generation unit 502.

The embedding data generation unit 502 is an example of a generation unit, encodes information related to the image data 511 transmitted by the image data obtaining unit 501, and generates embedding data 512. The embedding data 512 is formed by a dot pattern including a plurality of dots. In FIG. 5, for the sake of description convenience, an example of a case is illustrated in which the embedding data 512 is formed by a dot pattern including six dots (six circles surrounded by a dotted line). The embedding data generation unit 502 transmits the generated embedding data 512 to the embedding data arrangement unit 503.

Upon receiving the embedding data 512 from the embedding data generation unit 502, the embedding data arrangement unit 503 determines an image size, which has been specified in advance by a user, of the image data 511 at the time of printing out.

The embedding data arrangement unit 503 reads information related to a dividing method from the setting information storage unit 114 based on the determined image size. In an example of FIG. 5, a case is illustrated in which the embedding data arrangement unit 503 has read information 410 related to a dividing method.

The embedding data arrangement unit 503 generates arranged data 513 by arranging the embedding data 512 in each of areas obtained by dividing the image data 511 based on the information 410 related to the dividing method. The embedding data arrangement unit 503 transmits the generated arranged data 513 to the arranged data embedding unit 504.

The arranged data embedding unit 504 is an example of an embedding unit, and, upon receiving the arranged data 513 from the embedding data arrangement unit 503, generates embedding-data-embedded image data 514 by embedding the arranged data 513 in the image data 511. The arranged data embedding unit 504 transmits the generated embedding-data-embedded image data 514 to the output unit 505.

The output unit 505 is an example of an output unit, and, upon receiving the embedding-data-embedded image data 514 from the arranged data embedding unit 504, outputs the embedding-data-embedded image data 514 to the engine unit 207. With the above operations, the embedding-data-embedded image data 514 is printed out. Further, upon receiving the embedding-data-embedded image data 514 from the arranged data embedding unit 504, the output unit 505 outputs the embedding-data-embedded image data 514 to the network connection unit 206 by including information related to the image data 511. With the above operations, the embedding-data-embedded image data 514 (including the information related to the image data) is stored in the server apparatus 120.

As described above, in the present embodiment, embedding data is embedded in each of the areas obtained by dividing the image data into a plurality of areas. With the above operations, even in the case where printing is faint in some areas of the printed matter, the embedded embedding data can be extracted from other areas, and thus, it is possible to avoid a wrong determination result in determining existence or no-existence of the embedding data.

As a result, in verifying whether the printed matter is genuine or not, it is possible to avoid a wrong verification result in which it is determined to be not genuine in spite of the fact it is genuine, and the verification accuracy can be improved.

<5. Details of arranged data generated by the embedding data arrangement unit>

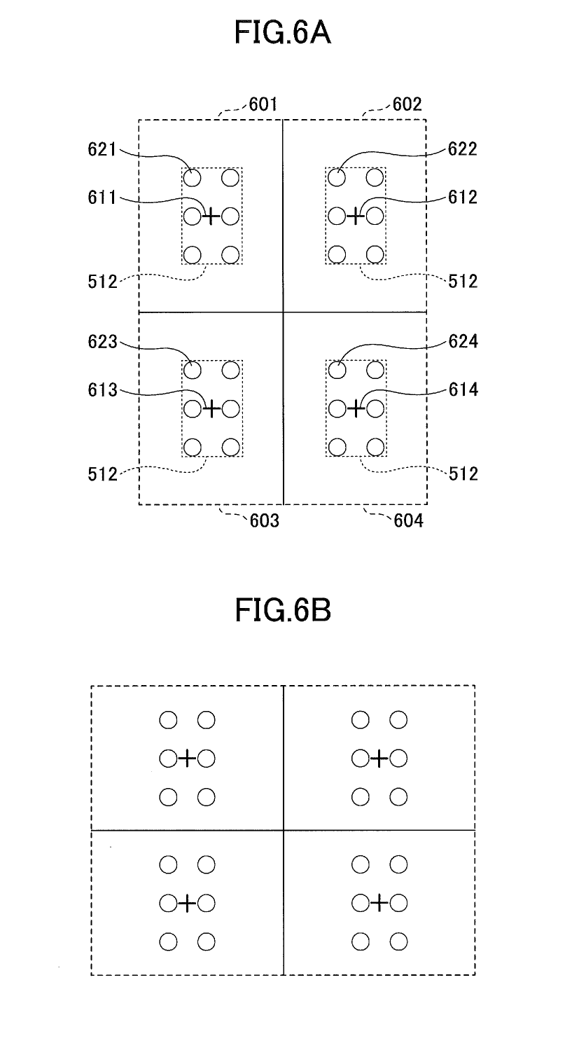

Next, details of the arranged data 513 generated by the embedding data arrangement unit 503 will be described. FIG. 6A and FIG. 6B are drawings illustrating examples of arranged data.

FIG. 6A illustrates an example of arranged data generated by arranging the embedding data 512 in each of areas obtained by dividing the image data 511, whose placement is vertical and whose size is A4, into four. FIG. 6B illustrates an example of arranged data generated by arranging the embedding data 512 in each of areas obtained by dividing the image data 511, whose placement is horizontal and whose size is A4, into four.

As illustrated in FIG. 6A and FIG. 6B, the embedding data 512 is arranged in each area in such a way that a location of the center of gravity of the embedding data 512 matches a location of the center of gravity of each area. With the above operations, the placement of the embedding data 512 in each area is identical. Descriptions will be made by taking FIG. 6A as an example.

As illustrated in FIG. 6A, in each of areas 601 to 604 in which the embedding data 512 is embedded, a location of the center of gravity of the embedding data 512 matches each of the locations 611 to 614 of the center of gravity of the areas.

With the above arrangement, a location of each of the dots included in the embedding data 512 (circles surrounded by a dotted line illustrated in

FIG. 6A) is defined uniquely with respect to each of the locations 611 to 614 of the center of gravity of the areas as an origin. Further, each of the dots included in the embedding data 512 arranged in the area 601 has a corresponding dot with the same coordinates in other areas 602 to 604. For example, coordinates of a dot 621 with respect to a location 611 of the center of gravity as an origin, is the same as coordinates of a dot 622 with respect to a location 612 of the center of gravity as an origin, is the same as coordinates of a dot 623 with respect to a location 613 of the center of gravity as an origin, and is the same as coordinates of a dot 624 with respect to a location 614 of the center of gravity as an origin.

It should be noted that the arrangement method of the embedding data 512 is not limited to the above. For example, the embedding data 512 may be arranged in each of the areas 601 to 604 in such a way that a location of the center of gravity of the embedding data 512 matches a location which is away from each location of the center of gravity of the areas 601 to 604 by a predetermined distance in a predetermined direction.

Alternatively, the embedding data 512 may be arranged in each of the areas 601 to 604 in such a way that a location of a predetermined dot of the embedding data 512 matches each of the location of the center of gravity of the areas 601 to 604. Further alternatively, the embedding data 512 may be arranged in each of the areas 601 to 604 in such a way that a location of a predetermined dot of the embedding data 512 matches a location which is away from each location of the center of gravity of the areas 601 to 604 by a predetermined distance in a predetermined direction.

In any case, in the present embodiment, the embedding data 512 is arranged at a location uniquely defined with respect to a predetermined reference point (here, location 611 to 614 of the center of gravity) in each of the areas 601 to 604.

<6. Flow of embedding process>

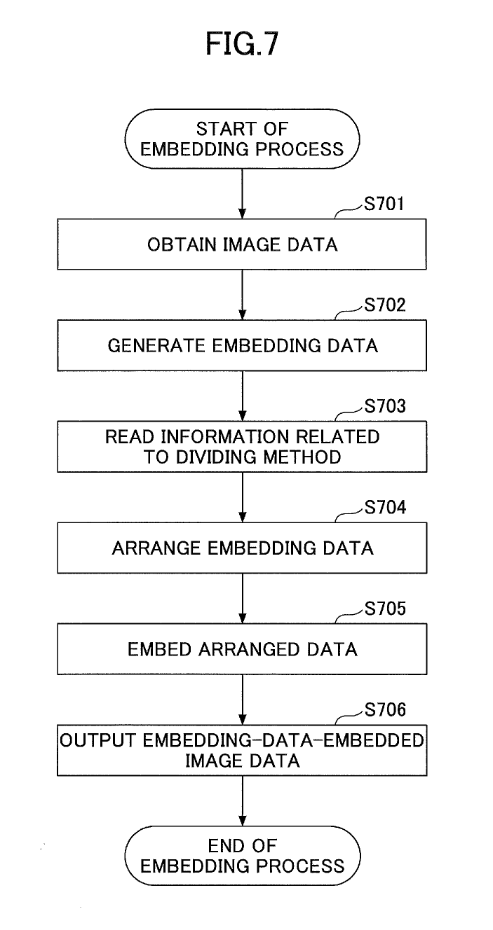

Next, a flow of an embedding process performed by the embedding process unit 111 will be described. FIG. 7 is a flowchart illustrating a flow of an embedding process. When image data is selected and a print instruction is input by a user of the image forming apparatus 110, an embedding process illustrated in FIG. 7 is started.

In step S701, the image data obtaining unit 501 obtains from the image data storage unit 113 the image data 511 selected by a user.

In step S702, the embedding data generation unit 502 generates embedding data 512 by encoding information related to the image data 511.

In step S703, the embedding data arrangement unit 503 reads information 410 related to a dividing method from the setting information storage unit 114 based on an image size specified by the user.

In step S704, the embedding data arrangement unit 503 generates arranged data 513 by arranging the embedding data 512 in each of the areas 601 to 604 obtained by dividing the image data 511 based on the information 410 related to the dividing method.

In step S705, the arranged data embedding unit 504 generates the embedding-data-embedded image data 514 by embedding the arranged data 513 in the image data 511.

In step S706, the output unit 505 outputs the embedding-data-embedded image data 514 to the engine unit 207 and the network connection unit 206.

<7. Functional structure of analysis unit of the image forming apparatus>

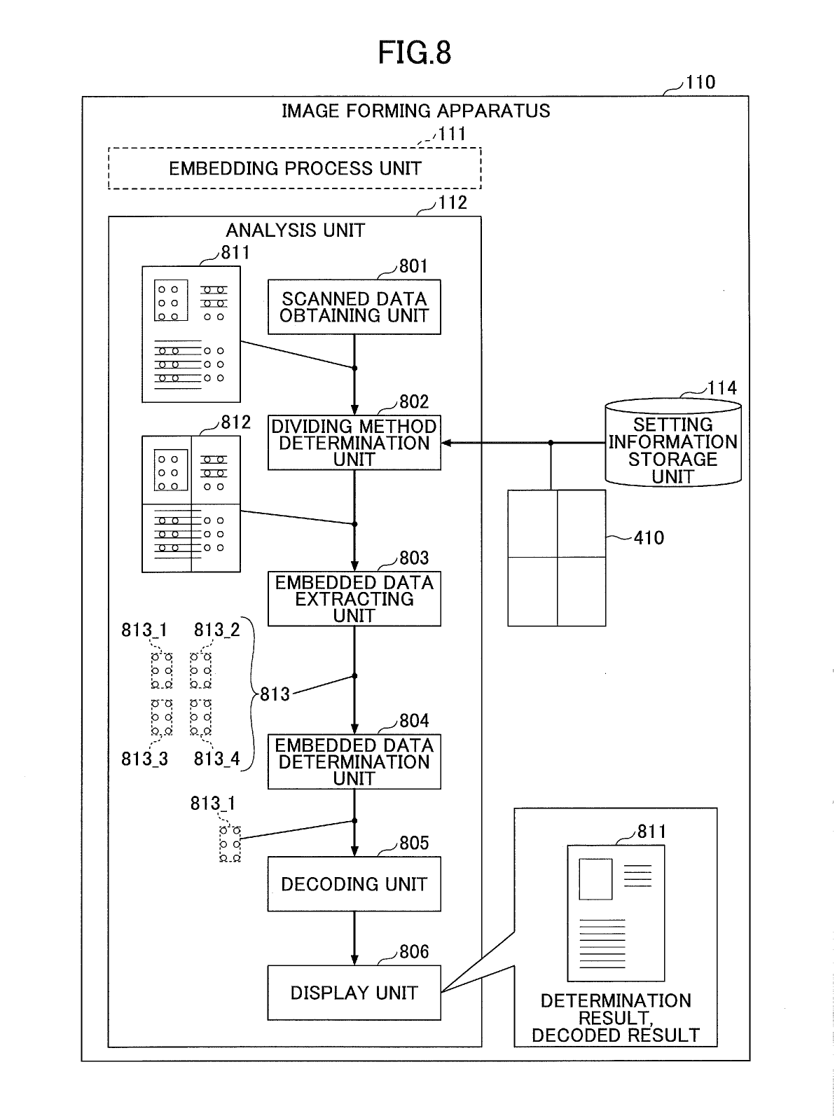

Next, a functional structure of an analysis unit 112 of the image forming apparatus 110 will be described. FIG. 8 is a drawing illustrating an example of a functional structure of the analysis unit 112 of the image forming apparatus 110.

As illustrated in FIG. 8, the analysis unit 112 includes a scanned data obtaining unit 801, a dividing method determination unit 802, an embedded data extracting unit 803, an embedded data determination unit 804, a decoding unit 805, and a display unit 806.

The scanned data obtaining unit 801 obtains, from the scanner unit 209, scanned data 811 obtained by the scanner unit 209 of the engine unit 207 by scanning the printed matter 140. Further, after binarizing the obtained scanned data 811, the scanned data obtaining unit 801 transmits the binarized result to the dividing method determination unit 802.

The dividing method determination unit 802 determines an image size of the printed matter 140 based on the scanned data 811, and reads information related to the dividing method from the setting information storage unit 114 based on the determined image size. In an example of FIG. 8, a state is illustrated in which the dividing method determination unit 802 has read information 410 related to the dividing method.

The embedded data extracting unit 803 is an example of an extracting unit, and extracts embedded data 813 from each of the areas obtained by dividing the scanned data 811 based on the information 410 related to the dividing method. The embedded data extracting unit 803 transmits the extracted embedded data 813 to the embedded data determination unit 804. It should be noted that an example of FIG. 8 illustrates a state in which embedded data items 813_1 to 813_4 are extracted from each of the areas obtained by dividing into four and transmitted to the embedded data determination unit 804.

The embedded data determination unit 804 is an example of a determination unit, and determines existence or no-existence of the embedding data based on the embedded data items 813_1 to 813_4 transmitted from the embedded data extracting unit 803. Further, the embedded data determination unit 804 transmits the embedded data to the decoding unit 805 in the case where it is determined that “the embedding data exists”. In an example of FIG. 8, a state is illustrated in which the embedded data 813_1 is transmitted from the embedded data determination unit 804.

The decoding unit 805 decodes the embedded data item 813_1 transmitted by the embedded data determination unit 804, and transmits a decoded result to the display unit 806.

The display unit 806 displays a result of determination of existence or no-existence of the embedding data determined by the embedded data determination unit 804 and a decoded result received from the decoding unit 805, together with the scanned data 811, on the user interface unit 205.

<8. Details of embedded data extracted by the embedded data extracting unit>

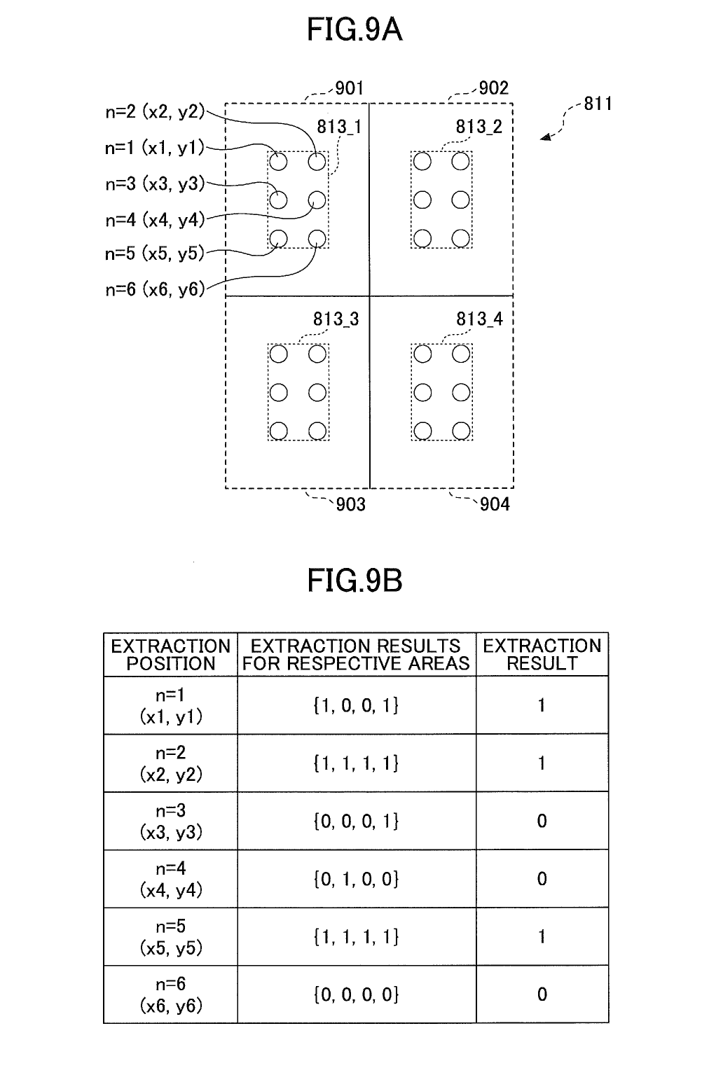

Next, details of the embedded data items 813_1 to 813_4 extracted by the embedded data extracting unit 803 will be described. FIG. 9A and FIG. 9B are examples of a method of extracting embedded data.

FIG. 9A is a drawing illustrating extraction location of the embedded data items 813_1 to 813_4. As described above, at the time of printing out, the embedding data is arranged at a location uniquely defined with respect to a predetermined reference point in each of the areas. Therefore, in each of areas 901 to 904 of the scanned data 811, a location of corresponding embedded data items 813_1 to 813_4 is defined uniquely.

For example, a set of coordinates (x1, y1) in a case, in which a location of the center of gravity of the area 901 is set as the origin, indicates an extraction location of an n-th (n=1) dot included in the embedded data item 813_1. Similarly, a set of coordinates (x2, y2) to a set of coordinates (x6, y6) are extraction locations of n-th (n=2 to 6) dots included in the embedded data item 813_1. Here, the embedded data extracting unit 803 extracts a dot from each extraction location.

Similarly, regarding the areas 902 to 904, the embedded data extraction unit 803 extracts a dot from each extraction location included in the embedded data items 813_2 to 813_4.

FIG. 9B is a drawing illustrating extraction results extracted by the embedded data extracting unit 803. As illustrated in FIG. 9B, extraction result information includes, as information items, an “extraction location”, an “extraction results for respective areas”, and an “extraction result”.

In the “extraction location”, a number, which indicates an extraction location, and coordinates (coordinates in a case in which a location of the center of gravity of the area is set as the origin) are stored. In the “extraction results for respective areas”, extraction results for respective areas for each extraction location are stored. The extraction results stored in the “extraction results for respective areas” are extraction results of dots at identical extraction location with respect to the location of the center of gravity of each area.

In the “extraction result”, information indicating whether a dot included in the embedding data has been extracted at each extraction location is stored based on the extraction results for each area.

An example of FIG. 9B illustrates that, regarding an extraction location specified by n=1, the dot included in the embedding data has been extracted from the area 901, and the dot included in the embedding data has not been extracted from the area 902. Further, the example of FIG. 9B illustrates that, regarding the extraction location specified by n=1, the dot included in the embedding data has not been extracted from the area 903, and the dot included in the embedding data has been extracted from the area 904.

The embedded data determination unit 802 determines that, based on the above extraction results with respect to the extraction location specified by n=1, the dot included in the embedding data has been extracted from the extraction location specified by n=1. As a result, in the case of n=1, “1” is stored in the “extraction result”.

Similarly, as described below, the embedded data determination unit 804 determines, based on the extraction results for respective areas, whether a dot included in the embedding data has been extracted for each extraction location. FIG. 9B illustrates an example in which the embedding data determination unit 804 determines that the dots included in the embedding data have been extracted from extraction locations specified by n=2 and 5, respectively. Further, FIG. 9B illustrates an example in which the embedding data determination unit 804 determines that the dots included in the embedding data have not been extracted from extraction locations specified by n=3, 4, and 6, respectively.

Based on the extraction results as described above, the embedding data determination unit 804 determines existence or no-existence of the embedding data. Specifically, in the case where it is determined that the dots have been extracted for all of the extraction locations, the embedding data determination unit 804 determines that “the embedding data exists”. On the other hand, in the case where it is determined that the dot has not been extracted for any one of the extraction locations (in the case where any one of the extraction results is “0”), the embedding data determination unit 804 determines that “the embedding data does not exist”.

As described above, in the present embodiment, embedding data embedded in each of the plurality of areas is extracted, extracted results are aggregated for each extraction location, and existence and no-existence of the embedding data is determined. With the above operations, even in the case where noise is included in some areas of the scanned data when the printed matter is scanned, the determination of whether the dot has been extracted is performed by including the extraction results for the extraction location in other areas, and thus, it is possible to avoid a wrong determination result in determining existence or no-existence of the embedding data.

As a result, in verifying whether the printed matter is genuine or not, it is possible to avoid a wrong verification result in which it is determined to be not genuine in spite of the fact it is genuine, and the verification accuracy can be improved.

<9. Flow of analysis process>

Next, a flow of an analysis process performed by the analysis unit 112 will be described.

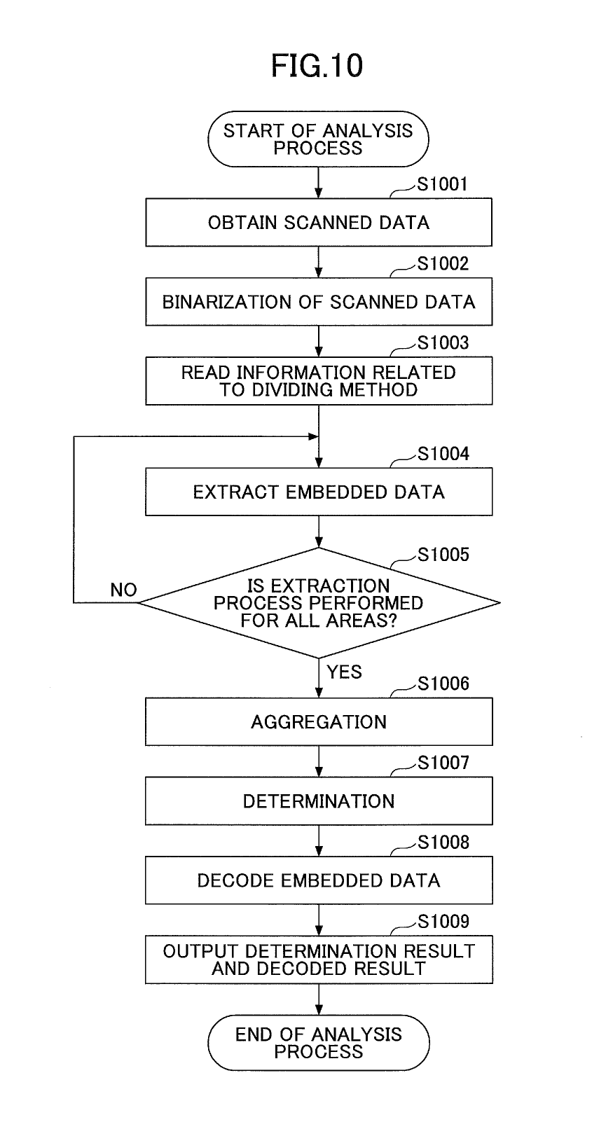

FIG. 10 is a flowchart illustrating the flow of the analysis process. When printed matter 140 is scanned by the scanner unit 209 of the engine unit 207, the analysis process illustrated in FIG. 10 is started. In step S1001, the scanned data obtaining unit 801 obtains the scanned data 811 from the scanner unit 209 of the engine unit 207.

In step S1002, the scanned data obtaining unit 801 binarizes the obtained scanned data 811.

In step S1003, the dividing method determination unit 802 determines an image size of the printed matter 140 based on the scanned data 811, and reads information related to the dividing method from the setting information storage unit 114 based on the determined image size.

In step S1004, the embedded data extraction unit 803 performs an extraction process for extracting the embedded data items 813_1 to 813_4 in the corresponding areas 901 to 904 in a case of dividing the scanned data 811 based on the information 410 related to the dividing method.

In step S1005, the embedded data extraction unit 803 determines whether the extraction process has been performed for all of the areas 901 to 904. In the case where it is determined that there is an area for which the extraction process has not been performed, the process returns to step S1004.

On the other hand, in the case where it is determined that the extraction process has been performed for all of the areas 901 to 904, the process moves to step S1006.

In step S1006, the embedded data determination unit 804 determines whether a dot included in the embedding data has been extracted from the respective areas 901 to 904 for each of the extraction locations (n=1 to 6).

In the case where it is determined that a dot included in the embedding data has been extracted from equal to or more than a predetermined number (e.g., half) of the areas, the embedded data determination unit 804 determines that a dot included in the embedding data has been extracted (extraction result=“1”). On the other hand, in the case where a number of the areas, for which it is determined that a dot included in the embedding data has been extracted, is less than the predetermined number (e.g., less than half), the embedded data determination unit 804 determines that a dot included in the embedding data has not been extracted (extraction result =“0”).

In step S1007, the embedded data determination unit 804 determines existence or no-existence of the embedding data. The embedded data determination unit 804 determines that “the embedding data exists” in the case where it is determined that a dot included in the embedding data has been extracted for all of the extraction locations (n=1 to 6). On the other hand, the embedded data determination unit 804 determines that “the embedding data does not exist” in the case where it is determined that a dot included in the embedding data has not been extracted for any one of the extraction locations.

In step S1008, in the case where it is determined by the embedded data determination unit 804 that “the embedding data exists”, the decoding unit 805 decodes the embedded data. The decoding unit 805 decodes the embedded data by forming a dot pattern using dots, of the dots extracted for each of the extraction locations (n=1 to 6) of the areas 901 to 904, extracted from any one of the areas.

In step S1009, the display unit 806 displays on the user interface unit 205 the determination result (existence or no-existence of the embedding data) determined in step S1007 and the decoded result in step S1008, along with the scanned data 811.

With the above operations, it is possible for a user to verify whether the printed matter 140 is genuine or not by scanning the printed matter 140.

<10. Summary>

As is clearly shown in the above description, an image forming apparatus 110 according to the present embodiment performs:
generating embedding data to be embedded in image data based on information related to the image data to be printed out;
embedding the generated embedding data in each of areas in a case of dividing the image data based on an image size at the time of printing out, in such a way that placement of the embedding data in each of the areas is identical; and
printing out as printed matter the image data in which the embedding data is embedded.

With the above operations, even in the case where printing is faint in some areas of the printed matter, embedded data can be extracted from other areas, and thus, it is possible to avoid a wrong determination result in determining existence or no-existence of the embedding data.

As a result, in verifying whether the printed matter is genuine or not, it is possible to avoid a wrong verification result in which it is determined to be not genuine in spite of the fact it is genuine, and the verification accuracy can be improved.

Further, the image forming apparatus 110 according to the present embodiment performs:
extracting a dot included in the embedded data from each of the extraction locations in the respective areas in a case of dividing the scanned data obtained by scanning the printed matter based on an image size;
determining that the dot has been extracted at the extraction location in the case where the dot included in the embedding data has been extracted from equal to or more than a predetermined number (e.g., equal to or more than half) of the areas; and
determining that “the embedding data exists” in the case where it is determined that the dot has been extracted at all of the extraction locations included in the embedding data.

With the above operations, even in the case where noise is included in some areas of the scanned data when the printed matter is scanned, the determination of whether the dot has been extracted is performed by including the extraction results in other areas, and thus, it is possible to avoid a wrong determination result in determining existence or no-existence of the embedding data.

As a result, in verifying whether the printed matter is genuine or not, it is possible to avoid a wrong verification result in which it is determined to be not genuine in spite of the fact it is genuine, and the verification accuracy can be improved.

### Second Embodiement

In the first embodiment described above, when determining whether a dot included in the embedding data has been extracted, extraction results for respective areas are aggregated for each extraction location.

With respect to the above, in a second embodiment, for each extraction location, extraction results for respective areas are first weighted based on weighting coefficients defined for respective areas, and then aggregated. This is because reliability of an extraction result regarding the dot included in the embedding data differs depending on whether background of the extraction location is white area or not. The second embodiment will be described below by mainly describing differences between the first and second embodiments.

<1. Details of embedded data extracted by the embedded data extracting unit>

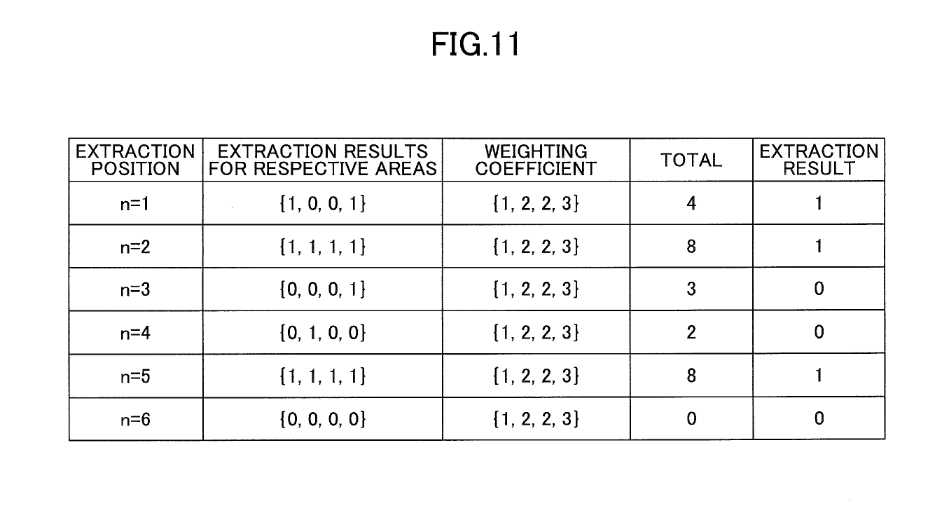

FIG. 11 is a drawing illustrating an extraction result extracted by the embedded data extracting unit. As illustrated in FIG. 11, extraction result information includes, as information items, an “extraction location”, an “extraction results for respective areas”, a “weighting coefficient”, a “total”, and an “extraction result”.

In the extraction result information, information stored in the “extraction location” and the “extraction results for respective areas” is the same as the information stored in the “extraction location” and the “extraction results for respective areas” described while making reference to Fig.9A and FIG. 9B in the first embodiment, and thus, here, the description will be omitted.

In the “weighting coefficient”, weighting coefficients, used for weighting the extraction results for respective areas, are stored. Regarding the weighting coefficients, the higher the probability of accurately extracting the dot included in the embedding data from an area, the larger the value will be assigned to the area. Specifically, the larger the proportion of white area in an area, of the areas 901 to 904 of the scanned data 811, the more accurately the dot included in the embedding data will be extracted from the area. Therefore, in the present embodiment, a weighting coefficient for an area, whose proportion of white area is equal to or greater than 80%, is “3”. Further, a weighting coefficient of an area, whose proportion of white area is greater than 30%, is “2”, and a weighting coefficient of an area, whose proportion of white area is equal to or less than 30%, is “1”.

It is illustrated in an example of FIG. 11 that a weighting coefficient for the area 901 is 1, weighting coefficients for the area 902 and the area 903 are 2, and a weighting coefficient for the area 904 is 4.

In the “total”, for each extraction location, a value, calculated by aggregating the results of multiplying extraction results for respective areas by corresponding weighting coefficients, is stored. In an example of FIG. 11, in the case of the extraction location n=1, the extraction results for respective areas are {1, 0, 0, 1} and the weighting coefficients are {1, 2, 2, 3}, and thus, the total is 1*1+0*2+0*2+1*3=4.

In the “extraction result”, in the case where a value stored in the “total” is equal to or greater than a predetermined value, a value (“1”), indicating that the dot included in the embedding data has been extracted at the extraction location, is stored. Further, in the case where a value stored in the “total” is less than the predetermined value, a value (“0”), indicating that the dot included in the embedding data has not been extracted at the extraction location, is stored in the “extraction result”. It should be noted that, in an example of FIG. 11, the predetermined value is four (4).

<2. Summary>

As is clearly shown in the above description, an image forming apparatus 110 according to the present embodiment performs:
defining a weighting coefficient for each of the areas in a case of dividing the scanned data obtained by scanning the printed matter based on an image size;
in order to aggregate the extraction results for respective areas for each of the extraction locations at which the dots included in the embedding data are located, aggregating the extraction results after weighting the extraction results based on the weighting coefficients defined for respective areas.

With the above operations, in extracting the dots included in the embedding data, it is possible to obtain an extraction result in which extraction results for those areas in which the dot can be accurately extracted are reflected, and thus, it is possible to avoid an erroneous determination result in determining existence or no-existence of the embedding data.

As a result, it is possible to further improve verification accuracy in verifying whether the printed matter is genuine or not.

### Third Embodiment

In the first and second embodiments, cases have been described in which an embedding process program and an analysis program are installed in the image forming apparatus 110, and the image forming apparatus 110 is caused to function as the embedding process unit 111 and the analysis unit 112.

With respect to the above, in a third embodiment, the embedding process program and the analysis program are installed in a terminal that generates image data, and the terminal is caused to function as the embedding process unit 111 and the analysis unit 112.

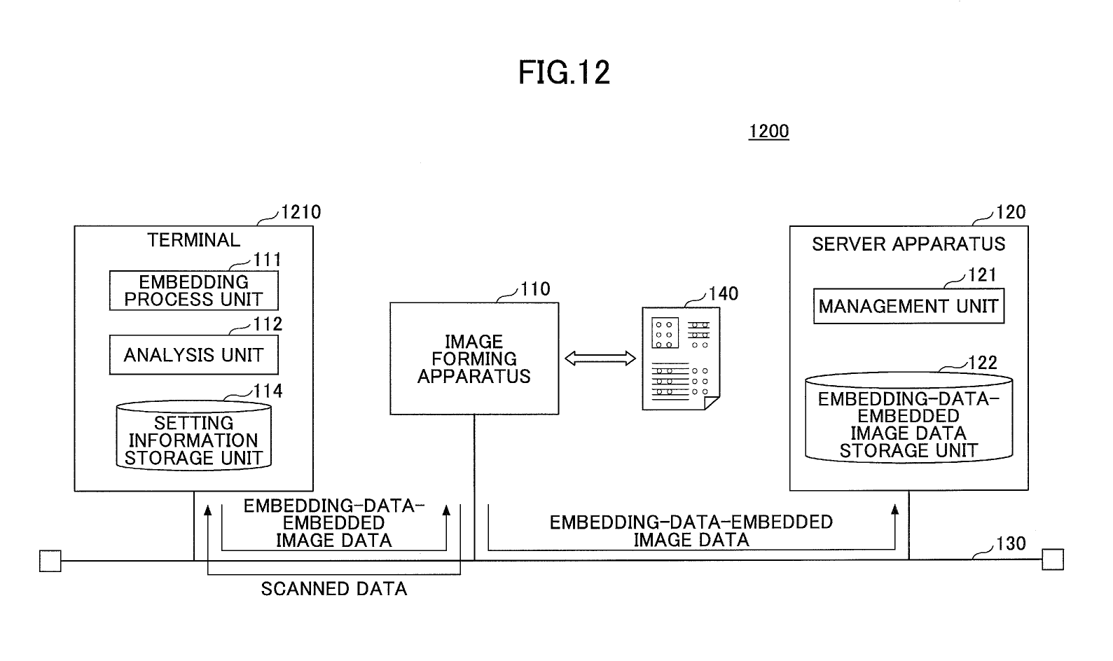

FIG. 12 is a second drawing illustrating an example of a system configuration of a printing system 1200. As illustrated in FIG. 12, the printing system 1200 includes a terminal 1210, an image forming apparatus 110, and a server apparatus 120. It should be noted that the terminal 1210, the image forming apparatus 110, and the server apparatus 120 are connected via a network 130.

The terminal 1210 is an apparatus including an application that generates image data and a driver for printing out the generated image data via the image forming apparatus 110. Further, an embedding process program and an analysis program are installed in the terminal 1210, and, by executing the programs, the terminal 1210 functions as the embedding process unit 111 and the analysis unit 112.

When printing out the generated image data via the image forming apparatus 110, the terminal 1210 functions as the embedding process unit 111 and transmits the embedding-data-embedded image data to the image forming apparatus 110. With the above operations, the printed matter 140 is printed out at the image forming apparatus 110.

Further, in the case where the scanned data, obtained by scanning the printed matter 140, is received from the image forming apparatus 110, the terminal 1210 functions as the analysis unit 112. With the above operations, it is possible for the terminal 1210 to display a determination result, pertaining to existence or no-existence of the embedding data embedded in the printed matter 140, and a decoded result of the embedded embedding data.

As described above, in the third embodiment, an embedding process program and an analysis program may be installed in the terminal 1210 and, by causing the terminal 1210 to function as the embedding process unit 111 and the analysis unit 112, it is possible to provide the similar effect as the first and second embodiments.

It should be noted that, in the third embodiment, similar to the first and second embodiments, it is assumed that the server apparatus 120 manages the embedding-data-embedded image data that is printed out at the image forming apparatus 110. However, the server apparatus 120 may be caused to function as a print server. In this case, an embedding process program and an analysis program may be installed in the server apparatus 120, and the server apparatus 120 may be caused to function as the embedding process unit 111 and the analysis unit 112.

### Fourth Embodiment

In the third embodiment, cases have been described in which the embedding process program and the analysis program are both installed in the terminal 1210 (the server apparatus 120), and the terminal 1210 (the server apparatus 120) is caused to function as the embedding process unit 111 and the analysis unit 112. With respect to the above, in the fourth embodiment, cases will be described in which the respective programs are separately installed (the embedding process program is installed in the terminal 1210 (or in the server apparatus 120) and the analysis program is installed in the image forming apparatus 110).

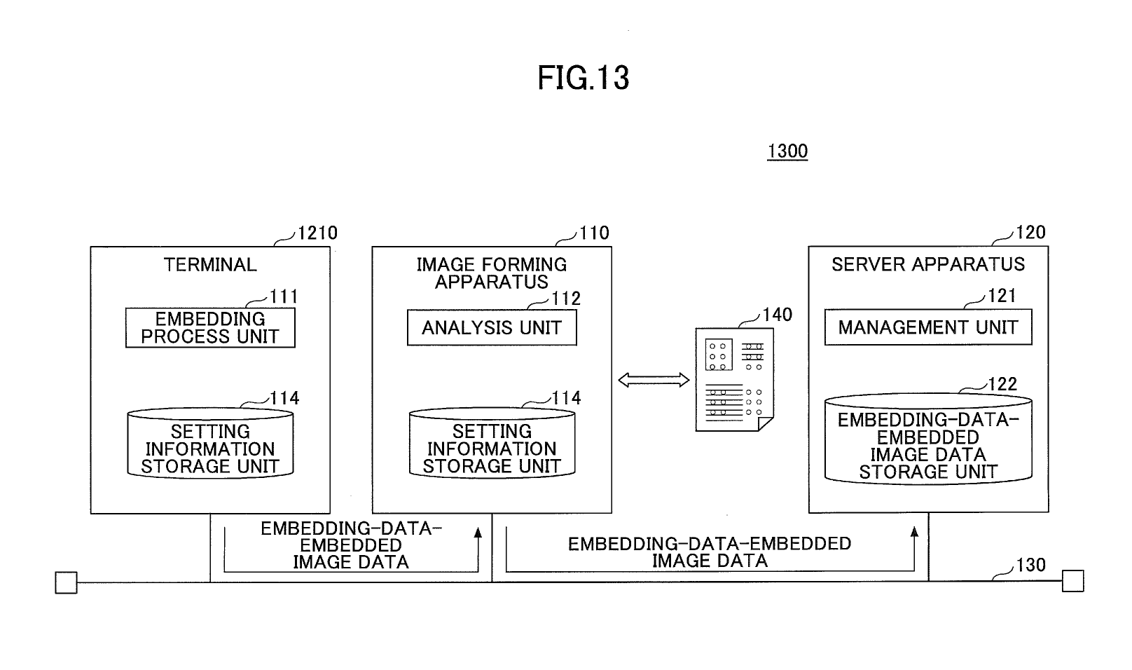

FIG. 13 is a third drawing illustrating an example of a system configuration of a printing system 1300. As illustrated in FIG. 13, in the terminal 1210, the embedding process program is installed, and, by executing the program, the terminal 1210 functions as the embedding process unit 111.

When printing out the generated image data via the image forming apparatus 110, the terminal 1210 functions as the embedding process unit 111 and transmits the embedding-data-embedded image data to the image forming apparatus 110. With the above operations, the printed matter 140 is printed out at the image forming apparatus 110.

Further, after having performed the scanning process, the image forming apparatus 110 functions as the analysis unit 112, and displays a determination result, pertaining to existence or no-existence of the embedding data embedded in the printed matter 140, and a decoding result of the embedded embedding data.

As described above, even in the case where the terminal 1210 (or the server apparatus 120) is caused to function as the embedding process unit 111 and the image forming apparatus 110 is caused to function as the analysis unit 112, it is possible to provide the similar effect as the first and second embodiments.

### Fifth Embodiment

In the third and fourth embodiments, the printing systems 1200 and 1300 have been formed by using the terminal 1210, the image forming apparatus 110, and the server apparatus 120. With respect to the above, in a fifth embodiment, the printing system is formed by using the terminal 1210, the printer 1410, the server apparatus 120, and a digital camera (or a smartphone) 1420.

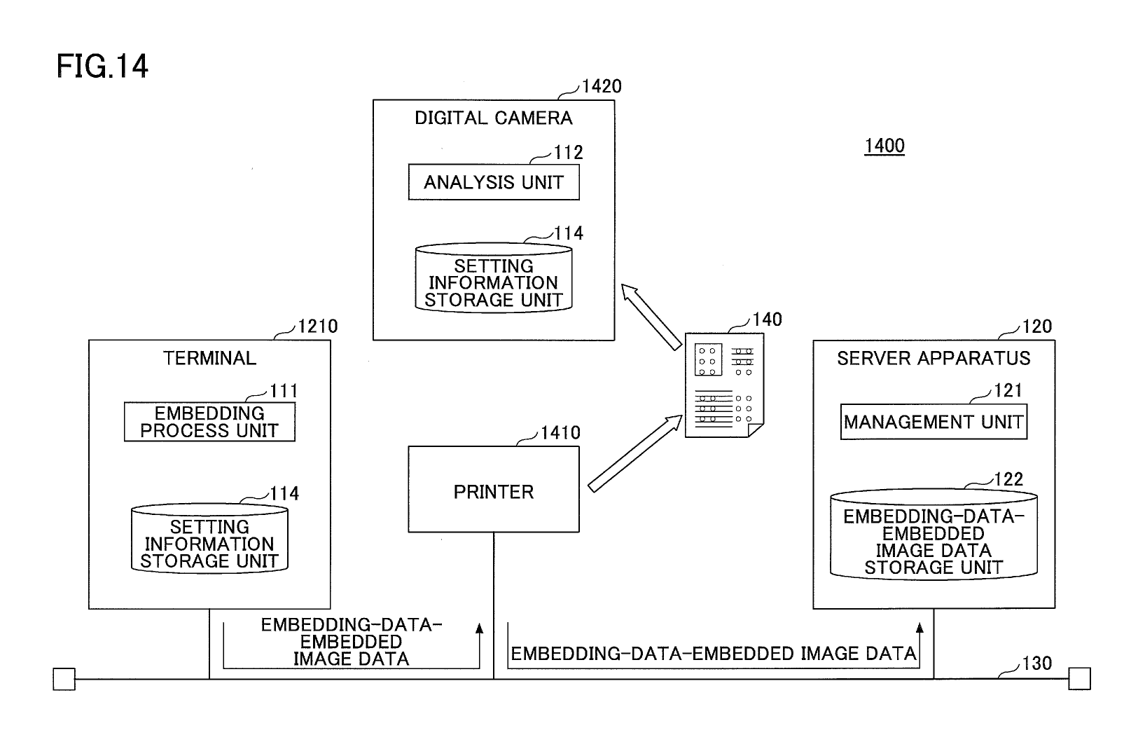

FIG. 14 is a fourth drawing illustrating an example of a system configuration of a printing system 1400. As illustrated in FIG. 14, the printing system 1400 includes the terminal 1210, the printer 1410, the server apparatus 120, and the digital camera (or smartphone) 1420. In the printing system 1400, the terminal 1210, the printer 1410, and the server apparatus 120 are connected to each other via the network 130.

In the terminal 1210, an embedding process program is installed, and, by executing the program, the terminal 1210 functions as the embedding process unit 111.

The printer 1410 is an apparatus that has a printing function for printing the embedding-data-embedded image data as the printed matter 140. In the present embodiment, the printer 1410 does not have a scanning function.

The digital camera 1420 is an apparatus that has an imaging function, and an analysis program is installed in the digital camera 1420. By executing the program, the digital camera 1420 functions as the analysis unit 112.

With the above arrangement, in the printing system 1400, the digital camera 1420 takes an image of the printed matter 140 obtained by causing the embedding-data-embedded image data to be printed out by the printer 1410, and thus, it is possible to determine existence or no-existence of the embedded embedding data. Further, it is possible to display a decoded result, obtained by causing the embedded embedding data to be decoded by the digital camera 1420, together with a determination result pertaining to existence or no-existence of the embedding data. In other words, by using the digital camera 1420 for verifying whether the printed matter is genuine or not, it is possible to provide the similar effect as the first and second embodiments.

It should be noted that the present invention is not limited to the configurations described in the above embodiments and configurations combined with other elements, or the like may be adopted. With respect to the embodiments described above, modifications may be possible without departing from the spirit of the present invention and may be defined accordingly depending on applications.

The present application is based on and claims the benefit of priority of Japanese Priority Application No. 2016-116521 filed on Jun. 10, 2016, the entire contents of which are hereby incorporated herein by reference.

What is claimed is:

1. A printing apparatus comprising: a processing circuitry configured to:
generate embedding data to be embedded in a print image to be printed out;
divide the print image into two or more areas, and embed the embedding data in each of the two or more areas in such a way that placement of the embedding data is identical in each of the areas; and
output the print image in which the embedding data is embedded.

2. The printing apparatus according to claim 1, wherein the processing circuitry embeds the embedding data in each of a number of the areas, the number corresponding to a size of the print image.

3. The printing apparatus according to claim 1, wherein the processing circuitry embeds the embedding data in each of the areas in such a way that the embedding data embedded in each of the areas is located at an identical location with respect to a reference point in each of the areas.

4. The printing apparatus according to claim 1, the processing circuit further configured to:
extract the embedded embedding data from each of the areas of a case of dividing scanned data obtained by scanning printed matter into a number of the areas, the number corresponding to a size of the printed matter; and
determine whether the embedding data is embedded in the scanned data based on a result of the extraction.

5. The printing apparatus according to claim 4, wherein the processing circuitry determines that the embedding data is embedded in the scanned data in the case where all of a plurality of dots that should be included in the embedding data are extracted.

6. The printing apparatus according to claim 5, wherein the processing circuitry determines that, for a set of dots each at an identical location with respect to a reference point in each of the areas, in the case where a predetermined number or greater of the dots are extracted, the dot that should be extracted at the location is extracted.

7. The printing apparatus according to claim 5, wherein the processing circuitry determines that, in the case where a value, obtained by weighting extraction results of dots each at an identical location with respect to a reference point in each of the areas, is equal to or greater than a predetermined value, the dot that should be extracted at the location is extracted.

8. The printing apparatus according to claim 7, wherein the processing circuitry performs the weighting based on a proportion of white area in each of the areas.

9. A printing method comprising:
generating embedding data to be embedded in a print image to be printed out;
embedding the embedding data in each of two or more areas in a case of dividing the print image into the two or more areas, in such a way that placement of the embedding data is identical in each of the areas; and
outputting the print image in which the embedding data is embedded.

10. A program medium including a program for causing a computer to execute:
generating embedding data to be embedded in a print image to be printed out;
dividing the print image into two or more areas, and embedding the embedding data in each of the two or more areas in such a way that placement of the embedding data is identical in each of the areas; and
outputting the print image in which the embedding data is embedded.
